(19) United States
(12) Patent Application Publication
(10) Pub. No.: US 2010/0294697 A1
(43) Pub. Date: Nov. 25, 2010

(54) PROCESS FOR THE DESULPHURISATION OF OLEFIN-CONTAINING FEED GASES

(75) Inventors: Thilo Von Trotha, Selm (DE); Frank Urner, Dortmund (DE)

Correspondence Address: MARSHALL & MELHORN, LLC, FOUR SEAGATE - EIGHTH FLOOR, TOLEDO, OH, 43604, US

(73) Assignee: UHDE GMBH, DORTMUND (DE)

(21) Appl. No.: 12/734,967

(22) PCT Filed: Nov. 18, 2008
(86) PCT No.: PCT/EP2008/009732

§ 371 Date: Jul. 28, 2010

(30) Foreign Application Priority Data
Dec. 7, 2007 (DE) 10 2007 059 243.6

(51) Int. Cl. C10G 67/06; C10G 35/04; B01J 19/00

(52) U.S. Cl. 208/99; 208/134; 422/600

(57) ABSTRACT

A process and a device for the hydrodesulphurisation of an olefin and hydrogen-containing feed gas utilizes a feed gas which can be mixed with further hydrogen and subdivided into at least two feed streams. The first feed stream is introduced separately into the reactor and is passed through a first catalyst bed which contains the catalyst pellets deposited on a suitable support or grid. The feed stream is heated in the hydrogenation reaction. Downstream of first catalyst bed, further feed gas is supplied which serves to cool the reaction gas permitting that the gas can then be passed through a second catalyst bed. Downstream of the second catalyst bed there may be further catalyst beds and further feed gas supply devices. The catalyst beds can be provided in the reactor in any number, type and shape. These process conditions ensure that a product gas be obtained which essentially contains no other sulphur compound than hydrogen sulphide.

The invention relates to a process for the hydrodesulphurisation of olefin and sulphur-containing process streams as obtained in crude oil refining plants, for example. By way of hydrogenation, the process according to this invention serves to convert all sulphur compounds contained in these streams completely or partly into hydrogen sulphide and the olefins contained in these streams completely or partly into alkanes. The invention also relates to a device which is used to run the process and is suited to implement the given process steps.

The products obtained from the mineral oil refining process often still contain sulphur-containing organic compounds which need to be removed from the products. Almost all products obtained from mineral oil must comply with low sulphur-content specifications with regard to further applications. This also applies to gases obtained from crude oil refining processes. Most of the subsequent applications require that such gases be free of sulphur since sulphur compounds are unwanted in applications for heating or synthesis purposes.

Gases which are frequently entrained by refinery streams are light olefin gases essentially comprising ethenes, propenes or butylenes. Examples are LPG (liquefied petroleum gas) or liquid gas. When the gas mixture is passed via a hydrogenating catalyst, part of the olefins contained in the gas mixture and the organic sulphur compounds are hydrogenated with the hydrogen also contained in the gas producing a gas mixture with an increased level of alkanes and hydrogen sulphide. On completion of the hydrogenation of the sulphur compounds, all organic sulphur compounds will have been converted into hydrogen sulphide which can subsequently be removed completely from the gas mixture in a gas scrubber to obtain a feed gas which is free of sulphur. Another gas that is frequently obtained in refining plants is hydrogen.

Many processes for the hydrotreating of hydrocarbons allow desulphurisation of both liquids and gases. The desulphurisation of liquid hydrocarbon mixtures is well-known and applied on a commercial scale. With regard to the state-of-the-art petrol types, the sulphur content must not exceed a maximum of 150 mg/kg petrol to prevent acid sulphur emissions. The desulphurisation of liquids involves the problem that the sulphur content of the product should be minimised on the one hand but that, on the other hand, major part of the olefins entrained in the hydrocarbons will also be hydrogenated in the hydrogenation. If hydrocarbons are used as fuel, olefins have a considerably higher knock resistance than simple alkanes. Since alkanes can be re-dehydrogenated if required, it is aimed to hydrogenate the sulphur compounds completely as the removal of the sulphur is of priority for ecological reasons. With regard to the sulphur compounds, the hydrogenation is therefore implemented with a stoichiometrically excessive amount of hydrogen. To reduce the sulphur content of fuels to the required value, it is standard practice to implement a hydrodesulphurisation in several successive steps.

The desulphurisation of gases is technically implemented analogously to the desulphurisation of fuels. The desulphurisation of gases is also performed in several successive steps. The state-of-the-art hydrodesulphurisation processes allow desulphurisation of olefin and hydrogen-containing feed gases to a residual sulphur content of few ppm. The desulphurisation process is strongly exothermic, especially in the presence of olefins, which in many cases shortens the lives of the used catalysts. The actual hydrogenation takes place in a fixed-bed reactor in which the gas is passed through so-called catalyst beds. These include a grid or bubble tray on which a carrier-deposited catalyst, i.e. a catalyst deposited on a suitable inert solid, is provided in a way that it is permeable to gas. Other than in the case of fuels, it is less problematic to have an elevated rate of alkanes in gases after hydrogenation.

WO 9829520 A1 describes a process for the dehydrogenation of hydrocarbons, especially for the removal of sulphur compounds in a multi-stage reactor. In a reactor, a mixture of liquid and gaseous hydrocarbons is caused to react with a hydrogen-containing reaction gas via a hydrogenation catalyst. In a subsequent process step, the liquid reaction products are separated from the gaseous ones and the liquid constituents are submitted to a second hydrogenation. The complete separation of the gaseous reaction products from the hydrocarbon streams is achieved in a stripping column. When separating the gaseous constituents the produced hydrogen sulphide is also obtained which may be removed by known processes such as gas scrubbing, for example. The hydrogenation reaction may be carried out as often as necessary until the sulphur content of the hydrocarbons obtained complies with the specification.

In the hydrodesulphurisation of gases, the catalyst required for the hydrogenation reaches a considerably higher temperature than in the case of the hydrogenation of liquids. The dissipation of the reaction heat is a problem since gases have a distinctly lower heat capacity than liquids. For this purpose it is necessary to use several hydrogenation steps in succession in the desulphurisation of gases or to dilute with a reflux. Although it is possible to largely minimise the sulphur content of the product gases if many reaction steps are provided, this also means an increased demand for equipment and thus high investment cost, a higher demand for space as well as increased operating cost by, for example, the operation of the reflux line.

The aim of the present invention is hence to provide a process which allows hydrogenation of olefin-containing feed gases for desulphurisation purposes at reduced expenditure but nevertheless permits to run the hydrogenation reliably by safe dissipation of the reaction heat. The process is to permit desulphurisation down to the requested sulphur content without any safety risks. The process is to use commercially available catalysts and, if possible, do without any costly equipment for cooling.

This aim is achieved according to the invention by means of a reactor which comprises several catalyst beds and has additional feed gas inlets downstream of each catalyst bed. The first part of a feed stream is introduced at the head of a hydrogenation reactor. The feed gas is heated up as a result of the hydrogenating reaction. By the subsequent addition of feed gas, the continuing gas stream is cooled down to the gas temperature required for subsequent hydrogenation and further hydrogenation is carried out. The flow rate of feed gas supplied downstream of the catalyst beds is controlled by valves which are installed downstream of the gas manifold for the feed devices. By the hydrogenation of the sulphur compounds, the product hydrogen sulphide is obtained, which can be removed in the downstream gas scrubber. The number of catalyst beds is selected so to ensure that the sulphur content of the product gas can be reduced to the specified value.

By supplying the feed gas for hydrogenation in accordance with the present invention, the reaction can be controlled in such a way that narrow temperature limits are maintained and, in addition to this, a specified low sulphur content can be adjusted in combination with a suitable process for removing the hydrogen sulphide. The reactor used to carry out the hydrogenation may consist of one single piece and does not require any additional devices for cooling the product gas. If the catalyst is deposited on suitable carriers, the carriers can be deposited on a grid, for example, or on bubble trays which allow the reaction gas to flow through at only little pressure loss. A multi-stage arrangement of the catalyst beds in one reactor allows to run the process with a low number of reactors, which constitutes an economical advantage in the exploitation of a site.

The invention claims a process for the hydrodesulphurisation of olefin-containing feedstock by means of a hydrogen-containing feed gas, in which
an olefin and hydrogen-containing feed mixture is passed through a reactor which is provided with a catalyst suitable for hydrodesulphurisation, and
the organic sulphur compounds contained in the olefin and hydrogen-containing feed mixture are hydrogenated completely or partly to give hydrogen sulphide, and
all or part of the olefins included in the feed mixture are/is hydrogenated to give alkanes,
   the process being characterised in that
the olefin-containing feed stream is subdivided into at least two feed streams before entering the reactor, and
the first feed stream is passed by means of suitable devices through a catalyst bed in the reactor, which is provided with a partial amount of a catalyst suitable for hydrodesulphurisation, thereby increasing the temperature of the reacting feed mixture, and
a second feed stream is supplied laterally into the reactor downstream of the first catalyst bed and added to the reaction mixture which has been heated in the first hydrogenation step so that the reaction mixture will cool down by being mixed with the second feed stream to a reaction temperature suitable for a further hydrodesulphurisation, and
the reaction mixture thus obtained is passed with the gas stream in the reactor through another partial amount of the catalyst suitable for hydrodesulphurisation so that a hydrogenated useful gas is obtained the sulphur compounds or olefin compounds or sulphur compounds and olefin compounds of which have been converted partly or completely into hydrogen sulphide or alkanes.

To bring the feed gas to the feed temperature required for the reaction, it is possible to pre-heat the first portion of the feed stream which is supplied via the reactor head by means of suitable devices. Such devices may be gas or oil fired burners, for example. To ensure that the plant be operated in an economically favourable way, a heat exchanger is preferably installed which uses the heat of the hot product gas at the outlet of the reactor for heating the feed gas. In the start-up phase of the reactor, the feed stream or the reactor or the feed stream and the reactor may be pre-heated to the hydrogenating temperature required. It is also possible to introduce a part stream of hot feed gas. The reaction temperature of the gas required to carry out the process according to the invention ranges between 150 and 500° C. The preferred temperature of the feed gas when being supplied to the reactor ranges between 250 and 350° C. and in a ideal case 300° C. The preferred pressure for running the process according to the invention ranges between 0.1 and 10 MPa. The hydrogenation may cause the temperature of the gas stream to increase to between 350 and 450° C.

To run the process according to the invention, the feed gas portion which is passed through the first reactor bed for hydrogenation preferentially amounts to approx. 5 to 15 percent by mass of the feed gas. Depending on the sulphur content and the hydrogenation heat to be expected, the feed portion for the first reactor bed may, however, be lower or higher. The feed gas portion which is passed through the first reactor bed for hydrogenation may amount to 1 to 99 percent by mass of the feed gas for carrying out the process according to the invention in the event of initiating parameters. The number of catalyst beds in the reactor depends essentially on the sulphur and olefin content in the gas to be hydrogenated. Depending on the specific case, the installation of additional catalyst beds may recommend itself as a favourable measure in the case of reduced plant space requirements.

To run the process, it is advisable to pass the gas to be hydrogenated downwards through the reactor. It is thus easier to maintain the positioning of the catalyst material in the catalyst bed. It is generally also possible to direct the gas flow upwards or sideways. In this case, however, specific devices will be required to avoid fluidisation of the catalyst bed.

The higher the sulphur content or the olefin content or the sulphur content and the olefin content in the reaction gas, the higher the demand for increasing the number of catalyst beds. If the sulphur portion or the olefin portion is elevated in the reaction, it is possible to install, for example, three catalyst stages in the reactor. When the reaction gas passes through a catalyst stage, it will be heated. Downstream of each catalyst stage, there is a feed device for cool reaction gas which is mixed with the gas stream from the catalyst bed thus cooling it down to a temperature adequate for further hydrogenation.

A reactor may be provided with any number of catalyst beds. In such a way it is possible to adjust the sulphur content of any feed gas by hydrogenation and cleaning to virtually any level. The organic sulphur compounds in the feed gas may be of any possible form. Most frequent constituents of low-molecular hydrocarbon gases are aliphatic mercaptans. Depending on the origin of the gas, it may also contain cyclic or aromatic sulphur compounds.

In the hydrogenation, the organic sulphur compounds are converted into hydrogen sulphide which may be removed from the product gas by gas scrubbing processes. Suitable gas scrubbing processes to remove hydrogen sulphide from gases are well known to the specialist from the production of refinery gases. Suitable, for example, are scrubbing processes with ethanol amines or alkylated polyalkylene glycols. By such processes the sulphur content of the product gas can be adjusted to below 100 ppb. It is also possible, however, to produce a product gas of higher sulphur content.

To diminish the concentration of the hydrogen sulphide, it is also possible to use chemical absorption processes. A suitable absorbent is zinc oxide, for example. These processes are preferably used in combination with the process according to the invention. However, it is also possible to hydrogenate process streams by the process according to the invention and subsequently route them to any further processing facility. Suitable for running the process according to the invention are actually all processes by which it is possible to hydrogenate the sulphur content of olefin and hydrogen-containing feed gases via the arrangement of catalyst beds in a reactor according to the invention.

Suitable as feed gases are almost all gases that contain sulphur. Typical feed gases are refinery gases which are obtained as fractions from the refining of crude oil. Examples in this context are residual gases from refinery processes. These usually have an increased content of hydrocarbons with 2 to 6 carbon atoms. Examples for such gas mixtures are LPG (liquefied petroleum gas), liquid gases or light benzine. It is also possible, of course, to use heavier hydrocarbon fractions provided these are gaseous under the conditions applied. Examples are petrol or paraffin oil. These may also contain elevated portions of higher olefins.

The only precondition for gases used in the process according to the invention is that they contain sulphur or olefins. The gases preferred for these purposes, however, contain both sulphur compounds and olefins. Especially these gases produce large amounts of heat in the hydrogenation so that it is necessary to connect several catalyst beds in series. The sulphur content of the feed gases may be of any level. The olefin content or the hydrogen content may also be of any level. The feed gas may be pre-cleaned before it is used in order to lower its sulphur content as compared to the content on delivery.

It may be advisable to admix further hydrogen to the feed gas, especially if complete desulphurisation is required. The hydrogen can be added to the feed gas before using it in the process according to the invention. It is also possible, however, to add the hydrogen after the feed stream has been divided. It is further possible to feed the hydrogen into the reactor and possibly use gas mixing devices. Finally the hydrogen can be added to the reaction stream at any point to adjust the hydrogen content to the requested value.

The invention especially claims a device for running the process according to the invention. The invention especially claims a reactor with at least two catalyst beds suitable for hydrogenation with at least one feed device for fresh feed gas installed downstream of the first catalyst bed.

The invention especially claims a device characterised in that
a pipeline conveying the feed gas subdivides the feed gas stream into two gas flows, and
the pipeline conveying the first feed stream leads from the head end into a reactor provided with several horizontally arranged catalyst beds, the reactor having at least two horizontally arranged catalyst beds, and
a second pipeline entering the reactor laterally is installed in the gas stream between the first and the second catalyst bed, which can introduce the second feed stream into the downward gas stream so that the feed mixture can flow through the second catalyst bed.

Prerequisite for implementing the process according to the invention is that the feed stream routed overhead can be preheated if its feed temperature is not adequate for hydrogenation. In a preferred embodiment, the device is therefore also provided with a heating device which may be in the form of gas or oil-fired burners. It is also possible to install an electric or steam-operated preheating system which may be advisable especially in the case of smaller sized plants. To configure the process in an economically advantageous way, the process according to the invention provides for the installation of heat exchangers in the feed track for supplying the first feed stream, which are used to pre-heat the feed gas by the product gas heated in the dehydrogenation process. However, it is also possible to pre-heat the feed gas by other heated reaction products.

Depending on the sulphur content and the requested hydrogenation degree the reactor may be provided with several catalyst beds. Instead of two catalyst beds, it is also possible to install three or more or any number. In such case, a device may be provided downstream of each catalyst bed by which fresh feed gas can be supplied into the reactor. These devices may be of the spray or jet type depending on whether a liquid or a gas is supplied. The devices used to feed the fresh reaction gas may be of any type that ensures that the gas flow is as free of turbulences as possible. The spray or jet devices may be fitted with controlling devices such as valves, for example.

In addition, the invention especially claims a device characterised in that
the pipeline conveying the feed gas subdivides the feed stream into several gas flows, and
the reactor is provided with additional, horizontally installed catalyst beds,
the reactor being provided with pipelines entering the reactor laterally which are used to introduce the additional feed streams into the downward gas flow so that the feed mixture can flow through the additional catalyst beds.

To maintain proper operating conditions, the amounts of cold feed gas must be dosed accurately. This is the only way to a precise control of the reactor temperature. Directly in the feed line for fresh feed gas a device is installed which serves to subdivide the gas flow. Downstream of this device there are valves which serve to precisely control the gas supply to the individual spray or jet devices of the reactor. This amount is dosed under consideration of the heated condition of the gas in the individual catalyst beds. In this way, the reactor temperature can be kept within the specified temperature limits.

The feed gas flow rate into the reactor is preferably controlled via the temperature. Therefore, temperature sensors or thermometers are installed in any place inside the reactor. It goes without saying that the device in accordance with the invention is also provided with the necessary control devices; in this context it is of no relevance if they are electric, electronic or mechanical. However, control of the gas supply is also possible via other signals such as, for instance, the sulphur or olefin content of the gas or a combination of these measured values.

The device according to the present invention should preferably require no cooling or heating devices. In the ideal case, dosing is to be implemented without such devices. Should other process conditions be selected, it is, however, also possible to provide the device with heating or cooling devices on condition that this is necessary to establish optimum operation.

The catalyst beds are arranged such to ensure adequate passage of the gas and a fast and effective reaction. The catalyst is preferably provided on a suitable carrier. The carriers according to the invention are deposited in the form of pellets, Raschig rings or porous moulded bodies. Suitable materials are known to the specialist as there are ceramic carriers or compression moulded bodies of aluminium oxide. Also suitable are silicic acids. The carriers are preferably provided on narrow-meshed grids used to support the catalysts adequately inside the reactor. It is also possible to use other suitable supports. The catalyst bed may be arranged as desired. It is possible to fix the catalyst in a round or angular-shaped support. It is also possible to arrange the catalyst bed concentrically to improve the gas flow. For this purpose, there is a round or angular-shaped recess in the catalyst bed.

The process according to the present invention uses catalysts which are commonly applied for hydrogenation reactions in the hydrodesulphurisation. To run the process according to the present invention, these are preferably catalysts containing nickel, cobalt or molybdenum. Suitable as well are other metals from group VIIIb of the periodic system of the elements. Known are also precious metals such as Pd or Pt or zeolithes which can be used to carry out a hydrodesulphurisation. As a matter of course, these metals or even other metals may be used for the catalyst in any desired combination.

The device according to the present invention may also include devices in any place desired which are required to ensure optimum operation. These may be valves, pumps, gas manifolds or gas conveying devices. These may also be sensors, thermometers, flow meters or analysers. These may be installed in any place of the device desired in accordance with the invention.

The process according to the invention and the device according to the invention permit the hydrodesulphurisation of olefin-containing feed gases with minor need of equipment and no need of costly cooling or heating devices. The desulphurisation is so effective that the sulphur content of the feed gas can be reduced down to the ppb range (ppb: parts per billion, 10⁻⁷ mole percent). The process allows reliable and safe temperature control and use.

The device according to the invention is illustrated in more detail in a drawing, the embodiment not being limited to the FIGURE in the drawing.

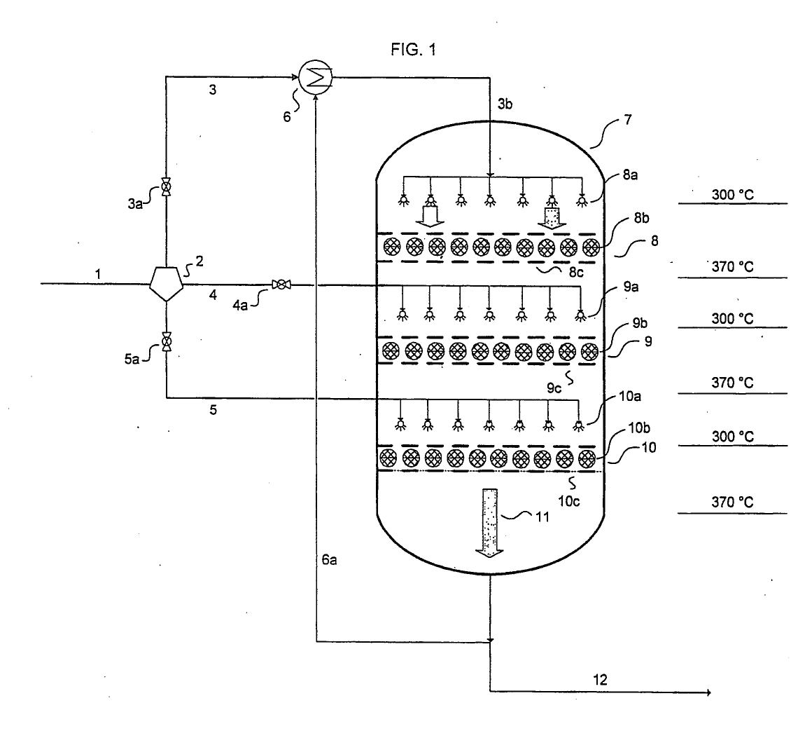

FIG. 1 shows a typical reactor according to the invention with three catalyst beds used to run a hydrodesulphurisation. The feed gas (1) from the feed tank is subdivided by a gas manifold (2) into three feed streams (3,4,5). Each gas or liquid feed line is provided with a valve (3a,4a,5a) used to control the feed stream. The first feed stream (3) is pre-heated by means of a heating device (6) or heat exchanger (via heat flow, 6a) and enters the reactor (7) via the reactor head (3b). In the ideal case, the inlet temperature of the first stream is 300° C. The first feed stream is introduced into the first catalyst bed (8) where its temperature rises. The catalyst bed (8) contains the catalyst (8b) on suitable carrier material and a grid (8c) or another adequate support. The outlet temperature at the bottom grid of the first catalyst bed (8) may be up to 390° C. Downstream of the first catalyst bed (8) a second feed gas stream (9a) is introduced. This makes the feed stream cool down, in the ideal case down to 300° C. This stream enters the second catalyst bed (9) with catalyst (9b) on a support (9c). Here, the gas stream heats up again by the hydrogenation reaction. To adjust the proper reaction temperature, further feed gas (10a) is introduced downstream of the catalyst bed. The gas stream is then introduced into a third catalyst bed (10) with catalyst (10b). Inside the reactor the catalyst is supported by grids (8c,9c,10c) or other supports. At the outlet of the reactor a gas stream (11) is obtained which essentially contains no other sulphur compound than hydrogen sulphide. The product gas (12) is obtained at the outlet of the reactor.

### LIST OF REFERENCES USED

1 Feed gas
2 Gas manifold
3 First feed stream
3a Control valve for first feed stream
3b First feed stream via reactor head
4 Second feed stream
4a Control valve for second feed stream
5 Third feed stream
5a Control valve for third feed stream
6 Heat exchanger
6a Heat flow
7 Reactor
8 First catalyst bed
8a Gas feed devices for first feed stream
8b Catalyst material in first catalyst bed
8c Support for first catalyst bed
9 Second catalyst bed
9a Gas feed devices for second feed stream
9b Catalyst material in second catalyst bed
9c Support for second catalyst bed
10 Third catalyst bed
10a Gas feed devices for third feed stream
10b Catalyst material in third catalyst bed
10c Support for third catalyst bed
11 Gas stream
12 Product gas

1-30. (canceled)

31. A process for the hydrodesulphurisation of olefin-containing feed gas by means of a hydrogen-containing feed gas, comprising:
passing an olefin and hydrogen-containing feed mixture through a reactor which is provided with a catalyst suitable for hydrodesulphurisation, and
partly or completely hydrogenating the organic sulphur compounds contained in the olefin and hydrogen-containing feed mixture to give hydrogen sulphide; and
hydrogenating all or part of the olefins included in the feed mixture to give alkanes,
wherein
the olefin-containing feed stream is subdivided into at least two feed streams before entering the reactor;
the first feed stream is passed by means of suitable devices through a catalyst bed in the reactor, which is provided with a partial amount of a catalyst suitable for hydrodesulphurisation, thereby increasing the temperature of the reacting feed mixture;
a second feed stream is supplied laterally into the reactor downstream of the first catalyst bed and added to the reaction mixture which has been heated in the first hydrogenation step so that the reaction mixture will cool down by being mixed with the second feed stream to a reaction temperature suitable for a further hydrodesulphurization; and
the reaction mixture thus obtained is passed with the gas stream in the reactor through another partial amount of the catalyst suitable for hydrodesulphurisation so that a hydrogenated useful gas is obtained the sulphur compounds and/or olefin compounds of which have been converted partly or completely into hydrogen sulphide or alkanes.

32. The process according to claim 31, wherein hydrogen is added before or after the feed gas stream has been divided.

33. The process according to claim 31, wherein the first feed gas stream which is supplied to the reactor head is pre-heated.

34. The process according to claim 31, wherein the mass portion of the first feed gas stream supplied to the head of the reactor amounts to between 1 and 99 percent by mass of the total feed gas stream.

35. The process according to claim 31, wherein the mass portion of the first feed gas stream supplied to the head of the reactor amounts to between 5 and 15 percent by mass of the total feed gas stream.

36. The process according to claim 31, wherein the useful gas obtained after passage through the first portion of the hydrodesulphurisation catalyst is passed through one or more further portions of hydrodesulphurisation catalyst.

37. The process according to claim 31, wherein the feed gas for the hydrodesulphurisation comprises a majority of olefins with 2 to 6 carbon atoms.

38. The process according to claim 31, wherein the feed gas for the hydrodesulphurization comprises a majority of higher olefins.

39. The process according to claim 31, wherein the hydrodesulphurisation is carried out at a temperature between 150 and 500° C.

40. The process according to claim 31, wherein the feed gas is introduced into the reactor at a temperature between 200 and 400° C.

41. The process according to claim 31, wherein the feed gas is introduced into the reactor at a temperature between 250 and 350° C.

42. The process according to claim 31, wherein the hydrodesulphurisation is carried out at a pressure between 0.1 and 10 MPa.

43. The process according to claim 31, wherein the feed gas is heated via heat exchange with the hydrogenated useful gas.

44. The process according to claim 31, wherein the hydrodesulphurisation process is followed by a gas scrubbing or hydrogen sulphide separation process.

45. The process according to claim 31, wherein the hydrodesulphurisation process is followed by an absorption process using a chemical absorbent.

46. A device comprising:
a pipeline conveying feed gas which is configured to subdivide the feed gas stream into two gas flows;
a pipeline conveying the first feed gas stream which leads from a head end into a reactor provided with several horizontally arranged catalyst beds, the reactor having at least two horizontally arranged catalyst beds; and
a second pipeline entering the reactor laterally which is installed in the gas stream between the first and the second catalyst bed, which can introduce the second feed gas stream into the downward gas stream so that the feed gas can flow through the second catalyst bed.

47. The device according to claim 46, wherein a feed device for admixing hydrogen is installed upstream or downstream of the point where the gas stream is divided.

48. The device according to claim 46, wherein the pipeline conveying the first feed gas stream is equipped with a heating device upstream of the reactor.

49. The device according to claim 48, wherein the device used for heating the first feed gas stream is a heat exchanger which uses the useful gas to heat up the feed gas.

50. The device according to claim 46, wherein:
the pipeline conveying the feed gas subdivides the feed gas stream into several gas flows;
the reactor is provided with additional horizontally arranged catalyst beds; and
further pipelines entering the reactor laterally are connected to the reactor, which are used to introduce the additional feed streams into the downward gas stream so that the feed gas can flow through the additional catalyst beds.

51. The device according to claim 46, wherein temperature measuring devices are installed at the gas feed inlets into the reactor and upstream and downstream of the catalyst beds.

52. The device according to claim 46, wherein valves which serve to control the gas flow, flow rate and the quantitative ratio of the individual feed gas supplies into the reactor are installed in the gas feed lines conveying the feed gas.

53. The device according to claim 52, wherein control devices are connected to the temperature sensors and the valves, which control the flow rate of the gases in dependence of the signals of the temperature sensors.

54. The device according to claim 46, wherein the catalyst consists of nickel-containing compounds.

55. The device according to claim 46, wherein the catalyst is deposited on carriers in the form of pellets, Raschig rings or porous molded bodies and the catalytically active material is deposited on these molded bodies.

56. The device according to claim 55, wherein the carriers consist of pressed aluminium oxide or pressed silicic acid.

57. The device according to claim 46, wherein the catalyst is provided on a grid or another suitable support installed in the reactor.

58. The device according to claim 57, wherein the grid or the support for the catalyst is round or angular-shaped.

59. The device according to claim 57, wherein the grid or the support for the catalyst is provided with a round or angular-shaped recess.
